(19) United States
(12) Patent Application Publication
(10) Pub. No.: US 2014/0250842 A1
(43) Pub. Date: Sep. 11, 2014

(54) EXCHANGEABLE SADDLE BACKPANEL

(71) Applicant: Jochen HENNIG, Muhlenberge/Haage (DE)

(72) Inventor: Jochen HENNIG, Muhlenberge/Haage (DE)

(21) Appl. No.: 14/192,983

(22) Filed: Feb. 28, 2014

(30) Foreign Application Priority Data
Mar. 7, 2013 (DE) 20 2013 100 987.3

(51) Int. Cl. B68C 1/02

(52) U.S. Cl. CPC B68C 1/02
USPC 54/44.1

(57) ABSTRACT

The invention relates to a saddle for horseback riding which has on the distal side of its cantle or on the rear end face thereof a one- or multipiece backpanel reversibly releasably attached by one or a plurality of fastening means; to a one- or multipiece backpanel including one or more fastening means for reversibly releasable connection; and a set comprising a saddle and a backpanel therefor, the said provided with complementary fastening means for reversibly releasable connection.

### PRIOR ART

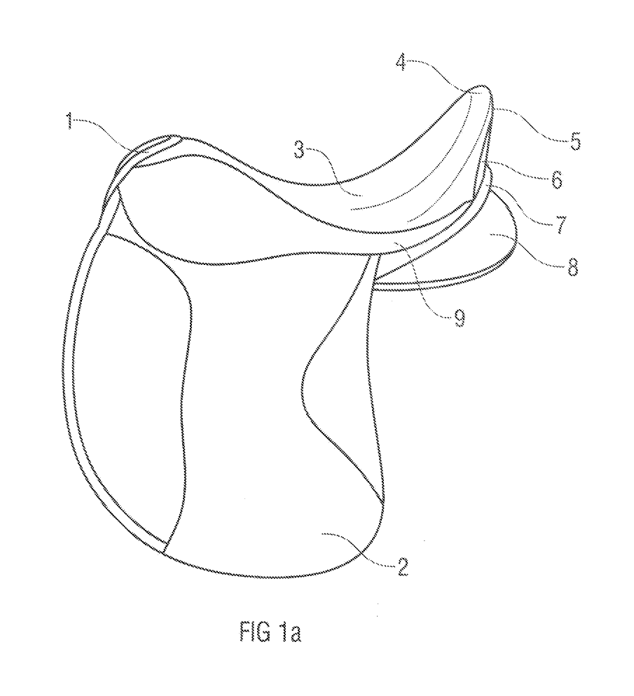

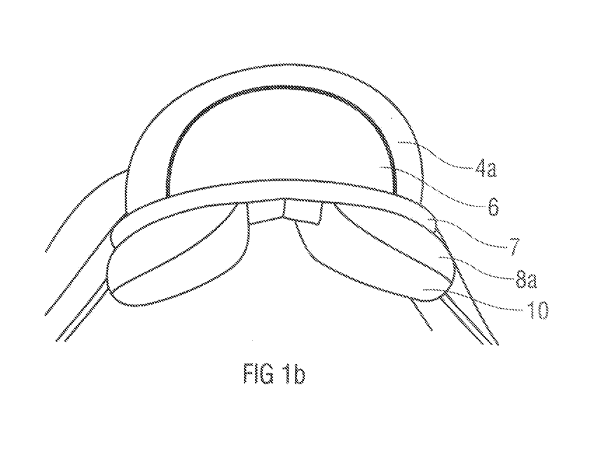

Modern horseback riding saddles frequently comprise a tree of a hard material, such tree padded and covered with a coat of a flexible material (leather, plastics or the like) stretched taut over it. Further, many saddles have at their rear end a cantle of which the rearwardly pointing end face terminates in a covering piece, mostly in a sickle or crescent shape, which is sewn into or on the saddle and then has a coating stretched, or adhesively bonded, in place over it, if needed (FIG. 1). This firmly integrated part of the coating (saddle cover) may be referred to as a backpanel and may be used for decorating or individualizing a saddle. To this end the backpanel may be provided with stickers, engravings, colouring, leather cuts, embroideries, embossings, burn-ins or decorative elements such as nails, rivets, splints or the like of metal, plastics or glass or the like. Because of the mechanical strain arising in riding use, these decorations must be connected firmly with, or incorporated in, the coating so as to ensure that they stay in place permanently.

In prior saddles, altering the motif previously applied to the backpanel is not readily possible as the backpanel or the motif applied to it is integrated firmly in the saddle cover. Altering the backpanel or the motif, if desired, calls for considerable craft skills. Should an equestrian, when changing a mount or for any other reason, desire to switch backpanels on short notice (e.g. at a horse show), this would not be possible with conventional saddles. With the features stated in the patent claims, the present invention is designed to remedy the situation.

### UNDERLYING OBJECT

Thus the object underlying the present invention is to eliminate the aforesaid shortcomings of the prior art and to enable the backpanel applied to the saddle to be fixed in place in a simple and/or reversible manner and thus to facilitate the exchange or replacement thereof. Another underlying object is to create a possibility of modifying the motif applied to a decorative backpanel, or to replace such motif, in a simple and/or reversible manner. Yet another object underlying the present invention is to provide within the saddle a space which is readily accessible and may be used for stowing articles, with articles so stowed in that space being protected particularly from rain or splash water.

### DESCRIPTION OF THE INVENTION

For achieving this object, a first inventive subject matter is to provide a horseback riding saddle characterized by a one- or multipiece backpanel reversibly releasably affixed by one or more fastening means to the distal side of the cantle or the rear surface thereof.

Further, the inventive backpanel is incorporated optionally in the saddle structure in a reversibly releasable force fit or shape fit. Thus, the backpanel is not firmly assembled to, or integrated in, the saddle or the saddle cover, but constitutes a separate element designed to be integrated in the saddle or the saddle cover by the said reversibly releasable fastening means. Thus, the backpanel inventively constitutes an exchangeable item.

Advantageous further developments and improvements of the subject matter of the invention are recited in the dependent claims.

In an embodiment of the invention, the inventive saddle comprises an exchangeable backpanel formed as an element of the saddle cover and attached to the rearwardly facing side of the cantle (i.e. at the rear face or distally thereof) by fastening means for reversible connection (such as snap-action buttons, Velcro tapes, swing-top closures, snap closures, zippers, detents, clamping studs or magnetic holders, etc.). The inventive backpanel is integrated in a shape fit or a force fit in the rear face of the saddle cover as an exchangeable part thereof. If desired, the inventive backpanel may be firmly connected with a plate member, which may be integrated in the saddle or the saddle cover and consists of wood, plastics or metal, for example. The backpanel, when formed as a one- or multipiece element of the cover, as a one- or multipiece door, as a one- or multipiece flap member or as a one- or multi-compartment drawer, may optionally have therebehind a cavity which extends into the cantle or into the body of the saddle, if desired, and may used for stowing objects, for example. The cavity behind the backpanel may hold electrical devices which are attached to the backpanel or integrated therewith. The cavity behind the backpanel, or the inside or the surface of the backpanel itself may be provided with one or more devices and/or fastening means so that electrical equipment may be stowed, attached or integrated therein or thereto, respectively. To this end, the cavity may advantageously be provided with means protecting it from water, or preventing the ingress of moisture, and may to this end be lined with a plastics film, an aluminium composite foil or the like, as desired.

Unless stated otherwise, any and all information herein relating to the inventive arrangement, to the orientation or elements of a saddle, or to the relative positions thereof, regarding direction or orientation or information of a similar nature refers to the normal seated position of an equestrian on a saddle used as intended.

In another embodiment, the inventive saddle may comprise an exchangeable backpanel designed as a door or flap member, with the backpanel provided with attachment means as well as with means of opening it (such as hinges, Velcro tapes, swing-top or snap closures, zippers, detents, damping studs or magnetic push-down closures or holders, as well as grips, buttons, recessed grips, etc.), any of these to cooperate with complementary members integrated in the cantle or its rear surface. The door or flap may be provided with means enabling it to be locked in place in the closed condition. In this embodiment, the inventive backpanel is integrated in the rear face of the saddle in the form of a door or flap adapted to be opened. An optional cavity may open behind a backpanel formed as a door or flap, such cavity extending into the cantle or into the saddle to hold objects. As an option, electrical devices may be mounted or integrated behind or inside a backpanel formed as a door or flap element. To this end, the cavity may be provided advantageously with means preventing the ingress of moisture and may be lined, for example, with a plastics film or an aluminium composite foil.

In yet another embodiment, the inventive saddle comprises an exchangeable backpanel in the form of a drawer which is integrated completely or partly into the back of the backpanel, said backpanel provided with suitable fastening means and with means for opening it (such as guide rails, Velcro tapes, swing-top closures, snap-on closures, zippers, detents, clamping studs or magnetic push-down closures or holders, or grips, buttons, recessed grips, etc.) to enable it to be withdrawn from the rear of the cantle. The drawer may be provided with means permitting it to be locked in place in the closed condition. In this embodiment, the inventive backpanel constitutes a drawer extending into the cantle or into the saddle, too, with the drawer integrated in the rear portion of the saddle. When designed to form a drawer, the backpanel may optionally receive electrical devices attached or integrated therein, with the drawer also provided with protection from the ingress of moisture.

As used herein, “exchangeable backpanel” denotes the rearward face on the rear end of the saddle, i.e. inside the cantle or on the rear surface thereof, such rear face preferably having a sickle or crescent shape and being reversibly releasably connected to the saddle by suitable fastening means in a shape fit and/or a force fit. The said backpanel is preferably designed to extend transversely of the horizontal longitudinal saddle axis, and substantially symmetrically, and particularly preferably symmetrically, on either side of that axis, across the cantle or its rear end face, respectively. Moreover, the said backpanel may be designed to constitute an element of the saddle cover or as a door, a flap, a drawer or the like, if desired. Further, the said backpanel may be provided with elements, indicia or motifs for decoration or individualization.

In yet another embodiment of the invention, the said exchangeable backpanel comprises one or more externally attached pockets or holders adapted to receive a mobile telephone or the like.

In yet another embodiment of the invention the said exchangeable backpanel is formed to constitute a decorating backpanel preferably on a perforated plate member. In this form, the backpanel supports decorative elements.

Within the meaning of the present invention, “fastening means” is meant to denote any and all connecting means known to the person skilled in the art and suited for the purposes of the invention, to—preferably—generate force- or shapefitting connections suited to reversibly releasably connect the elements to be attached to each other in accordance with the invention. Also in accordance with the invention, “fastening means” comprehends the majority of similar or dissimilar connecting means. Many of the said connecting means are regularly used as established by general technical knowledge. Within the meaning of the invention, “reversibly connect” refers to the possibility of effecting a non-destructive release or separation of previously connected elements, especially without the opening of seams. In another embodiment of the invention, the fastening means are suited to enable such connection to be made and/or opened without a use of tools.

Within the present invention, “attached by fastening means” denotes that, for exchange or replacement, the referenced member—such as the inventive backpanel—is reversibly releasably affixed in- or outside the saddle or in the saddle cover.

Within the meaning of the present invention, “electrical devices” denotes any and all electrically or electronically operated equipment, as is known to those knowledgeable in horseback riding. Within the meaning of the invention, it should be possible to attach such equipment firmly and reversibly to the saddle, a task which the inventive backpanel is eminently suited to perform. The term “electrical devices” designates not only such equipment itself but also its power supply accessories. As non-limiting examples, attention is directed to rear lights, warning lights, flashing lights, fog warning lights, communication devices (such as mobile telephones, loudspeakers, walkie-talkies, headphones, etc.), locating devices (such as emergency beacons), anti-theft devices or power supply facilities or mounts for such equipment (for safe transport or operation, such as dry cells or chargeable batteries).

The present invention not only enables an equestrian to generate decorative or individualizing effects, as desirable for leisure-time activities, horse shows and other events; in addition, it secures substantial functional improvements of the saddle. By enabling integrated electrical equipment to be housed behind or in the inventive backpanel (warning lights, rear lights, locating elements, navigation equipment, anti-theft devices or the like) while protected from wet moisture or humidity, the present invention contributes valuably to an improved safety of the animal and its rider.

In another advantageous embodiment of the invention, the inventive backpanel applied to a plate in the form of a perforated planar member, which as such is suited especially for receiving one or more decorative elements. A perforated plate member may have one or a plurality of holes therethrough, arranged in a regular or irregular pattern. Perforated plates of this kind are used frequently for assembling a desired decorative motif from a plurality of decorative elements (e.g. in a mosaic pattern). Decorative elements of this kind may be coloured or black-and-white and may comprise letters (such as initials), numerals, symbols, emoticons, arms or other indicia that lend themselves to graphic representation (such as little hearts, animal motifs, etc.), or smaller elements (such as paste gems, sequins, nails, rivets, splints, etc.) suited to be assembled to represent larger designs or motifs. The materials suited to be used for the said decorative elements may be any from a broad plurality of materials, such as wood, leather, bast, bamboo, textiles, metals, plastics, coated plastics films, glass or minerals (such as semi-precious gems). Such decorative elements are easily altered or exchanged by the user especially if the said perforated pate members are used.

In another preferred embodiment the decorative motif applied to the inventive backpanel is secured by fastening means in a manner to be exchangeable or alterable without any use of tools.

Another inventive subject matter is an exchangeable one- or multipiece backpanel for a saddle intended for horseback riding, which backpanel, as described above, is formed as an element of the saddle cover in the form of a door, a flap or a drawer, the said backpanel including one or more fastening means for the reversibly releasable attachment thereof.

Yet another inventive subject matter is a set comprising a horseback riding saddle and a backpanel characterized in that (a) the backpanel is designed as recited above, (b) the saddle includes one or more fastening means intended for reversibly releasable connection, and (c) said fastening means of (a), as well as the said fastening means of (b), are suited for making a reversibly releasable connection.

### FIGURES

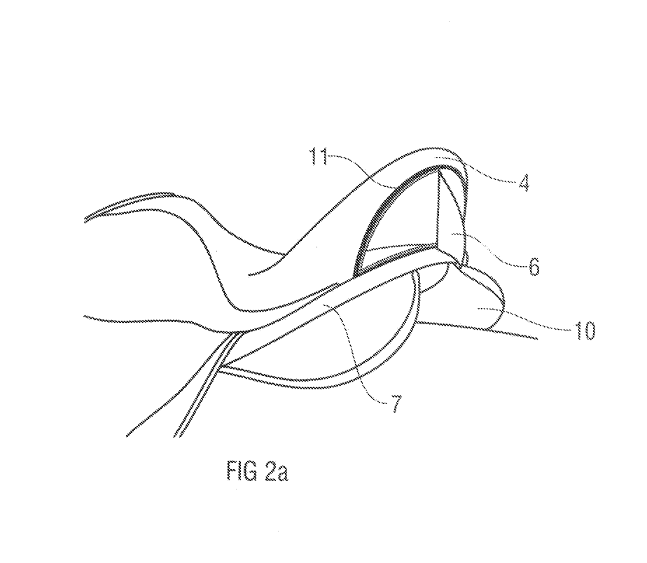

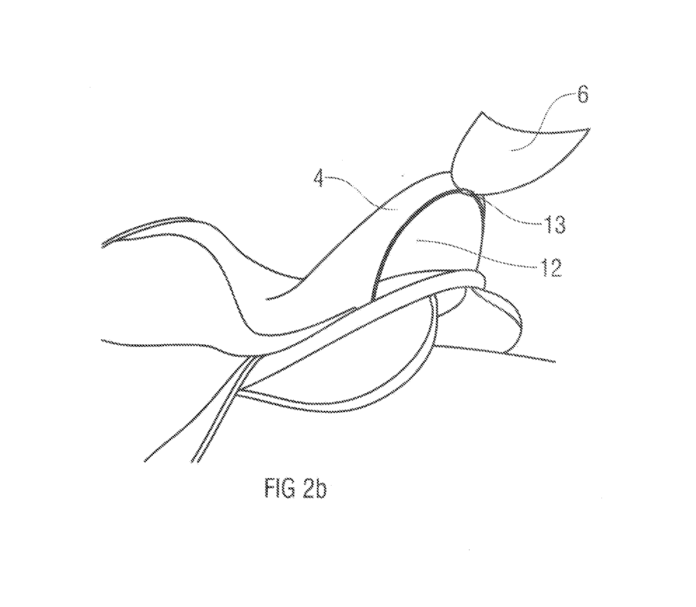

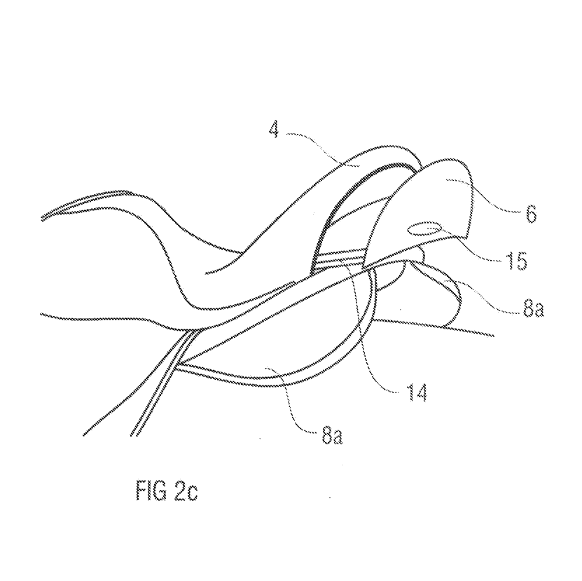

Embodiments of the invention are shown especially in FIG. 2.

### DESCRIPTION OF THE FIGURES

FIG. 1a shows the basic constituents of a conventional saddle:

FIG. 1b shows a rear view of a conventional saddle with a frontal view of the backpanel;

FIG. 2a shows an inventive saddle with an exchangeable backpanel flexibly designed with Velcro tapes as part of the saddle cover;

FIG. 2b shows an inventive saddle with an exchangeable backpanel formed as a flap member hinge to the cantle; and

FIG. 2c shows an inventive saddle with an exchangeable backpanel formed to constitute a drawer.

### LIST OF REFERENCE NUMERALS

1 protruding front edge

2 panel

3 seat

4 cantle

4a rear face of cantle

5 rear surface of cantle top

6 backpanel

7 protruding rear edge

8 cushion

8a cushioning wedge

9 small pocket in padding

10 padding leather

11 zipper

12 cavity

13 hinge

14 guide rail

15 recessed grip

1. A saddle for horseback riding, characterized in that the distal side of the cantle or the rear end face has a one- or multipiece backpanel attached thereto in a reversibly releasable manner by one or more fastening means

2. The saddle of claim 1, characterized by a cavity disposed behind the backpanel and preferably within the cantle, said cavity extending into the body of the saddle, if desired.

3. The saddle of claim 1, wherein the said backpanel is designed to form
a) a one- or multipiece element of the saddle cover,
b) a one- or multipiece door or flap, or
c) a one- or multipiece drawer.

4. The saddle of claim 1, wherein the said backpanel is a decorative backpanel.

5. The saddle of claim 1, wherein the said backpanel or the said cavity is formed with one or more devices and/or fastening means for receiving or holding electrical equipment.

6. The saddle of claim 1, wherein the said backpanel is applied to one or more plate elements, said plate elements are optionally perforated

7. A one- or multipiece backpanel for a horseback riding saddle for fastening at the distal side of the cantle or the rear end face thereof, characterized in that the said backpanel has one or more fastening means for reversibly releasable connection.

8. The backpanel of claim 7, characterized in that it forms
a) a one- or multipiece element of the saddle cover,
b) a one- or multipiece door or flap, or
c) a one- or multipiece drawer.

9. The backpanel of claim 7, which is a decorative backpanel.

10. The backpanel of claim 7, which comprises fastening means for receiving or holding electrical equipment.

11. The backpanel of claim 7, which is applied to one or more plate elements, optionally perforated plate elements.

12. A set comprising a horseback riding saddle and a backpanel, wherein
a) the backpanel is designed as defined in claim 7;
b) the saddle has one or more fastening means for reversibly releasable connection; and
c) the said fastening means of (a) and the said fastening means of (b) are suited to cooperatively make a reversibly releasable connection.
